(19) United States
(12) Patent Application Publication
(10) Pub. No.: US 2008/0168852 A1
(43) Pub. Date: Jul. 17, 2008

(54) Nut assembly for linear actuator leadscrew

(75) Inventors: Tung-Hsin Chen, Taichung (TW); Chien-Chih Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/654,219

(22) Filed: Jan. 16, 2007

(51) Int. Cl. F16H 25/24

(52) U.S. Cl. 74/89.23

(57) ABSTRACT

The present invention claims for a nut assembly for a linear actuator is applied to an actuator around a lead screw and an inner tube thereof. The nut assembly of the present invention comprises: a lead nut, assembled to the lead screw and externally engaged with the end of the inner tube; a locking nut, assembled at the end of the inner tube; and a safety nut, assembled to the lead screw and be retained by the lead nut and locking nut at its opposite ends. Thereby, the safety nut is capable of bearing a thrust load or a tensile load burdened to the linear actuator when the screw threads of the lead nut are damaged.

### BACKGROUND OF THE INVENTION

1. Technical Field

The present invention relates to linear actuators and, more particularly, to a nut assembly assembled to a lead screw of a linear actuator which is characterized by an improved safety nut.

2. Description of Related Art

As can be seen in FIG. 1, a linear actuator is a load-bearing mechanism using a motor 10 and a driving assembly 11 containing plural gears and linkages to revolve a lead screw 12 and implementing a lead nut 13 combined with the lead screw 12 to direct an inner tube 14 to perform movement of linear extension or contraction within an outer tube 15. Such linear actuators are typically applied to hospital beds or other devices where linear movements of components are required.

Problems with foresaid lead nut 13 concerning thread damage could be a considerable issue of a linear actuator and some possible causes of the thread damage are discussed below. As the lead nut 13 functions to transform the rotational force of the lead screw 12 into a linear thrust force and affect the inner tube 14 as well as the workpiece (not shown in the drawings) carried thereon to move correspondingly, the screw threads of the lead nut 13 bearing the brunt of the load could be unavoidably worn after an interval of use. Also, conventionally, for reducing noise from friction between the lead nut 13 and lead screw 12, the lead nut 13 may be made of plastic material. The screw threads of such plastic lead nut 13 could be worn even more severely for rubbing against the metal-made lead screw 12. Besides, when the distal portion of the linear actuator encounters excessive obstructive force during operation, the obstructive force may pass return to interfere with the inner tube 14 and may subsequently cause disintegration to the lead nut 13.

At all events, once the lead nut 13 is damaged, it is unable to bear the loads normally, and consequently, the linear actuator fails to work, which may cause the workpiece carried thereon out of control or may induce other serious influence upon the workpiece or the peripheral devices thereof.

To address foresaid defect, one solution about implementing a safety nut has been suggested. As shown in FIGS. 1 and 2, a safety nut 20 is assembled to the lead screw 12 and settled inside of the head end 131 of the lead nut 13. Thereby, in case of thread damage of the lead nut 13, the safety nut 20 can supersede the lead nut 13 for bearing loads so the linear actuator can be ensured from losing its function immediately. Thus the safety nut 20 can act as a safe guard of the linear actuator and facilitates enhancing operational safety.

However, a major problem with such a strategy is that the safety nut 20 can only bear loads come in a adverse direction. In FIG. 2, Arrow A represents a thrust force that the linear actuator is bearing, and such thrust force is an adverse load to the safety nut 20. Hence, when thread damage of the lead nut 13 occurs and the lead nut 13 can no more bear the force coming along A direction, the safety nut 20 can serve substitutively as bearing the load and prevent the workpiece from losing control from the linear actuator. Thereupon, the lead nut 13, inner tube 14 and workpiece can remain at the initial positions.

Nevertheless, when the actuator is bearing a tensile load as designated by Arrow B in FIG. 2, since the tensile load does not come adversely to the safety nut 20, once thread damage of the lead nut 13 occurs and the lead nut 13 can no more bear the force of B direction, the lead nut 13 could be dragged out by the tensile force directly and depart from the safety nut 20. That is to say, the safety nut 20 cannot affect the lead nut 13 under this circumstance.

To make short of the matter, such conventional safety nut 20 can only function when the linear actuator is bearing a thrust load, and is not adapted to linear actuators bearing tensile loads.

Besides, conventionally, the head end 131 of the lead nut 13 accommodates the round-contoured safety nut 20 with a round recess 132. Therefore, the safety nut 20 and the round recess 132 of the lead nut 13 are mutually retained from relatively revolving by merely the friction therebetween. Thus, when the torque generated from the rotation of the lead screw 12 is greater than foresaid friction, the safety nut 20 could not be fixedly retained by the lead nut 13 any longer and subsequently drawn to rotate with the lead screw 12. In this way, the safety nut 20 could lose the function of acting instead of the lead nut 13 to bear loads.

### SUMMARY OF THE INVENTION

The present invention has been accomplished under these circumstances in view and provides a nut assembly for a linear actuator with a safety assembly is capable of substitutively bearing loads despite the linear actuator is bearing a tensile load or a thrust load acting as a safe guard regardless of. In other words, the disclosed safety nut is capable of dual direction loads.

The disclosed nut assembly for a linear actuator, which is applied to a lead screw and an inner tube of the linear actuator and comprises:

a lead nut, assembled to the lead screw and externally engaged with the end of the inner tube;

a locking nut, assembled at the end of the inner tube; and

a safety nut, assembled to the lead screw and be retained by the lead nut and locking nut at its opposite ends.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a sectional view of a conventional linear actuator;

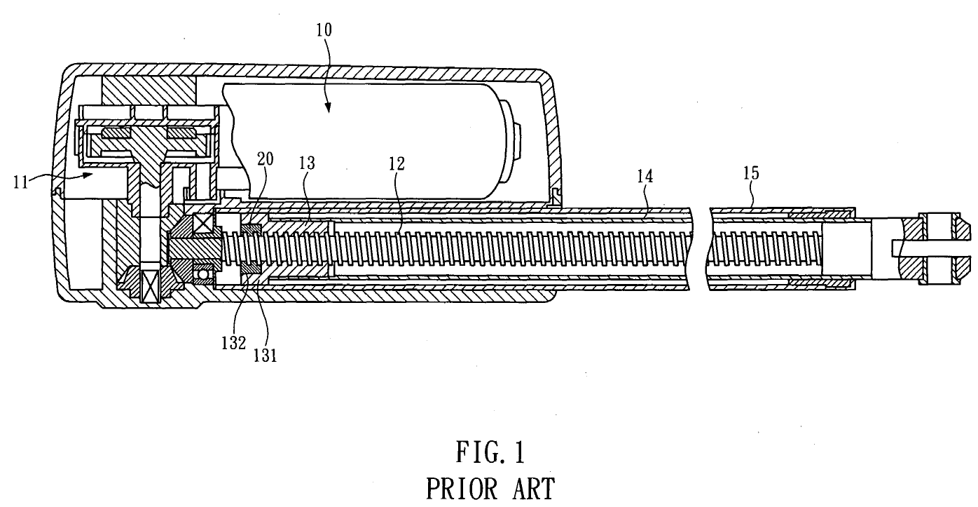

FIG. 2 is a schematic drawing illustrating a lead nut and a safety nut assembled to the conventional linear actuator;

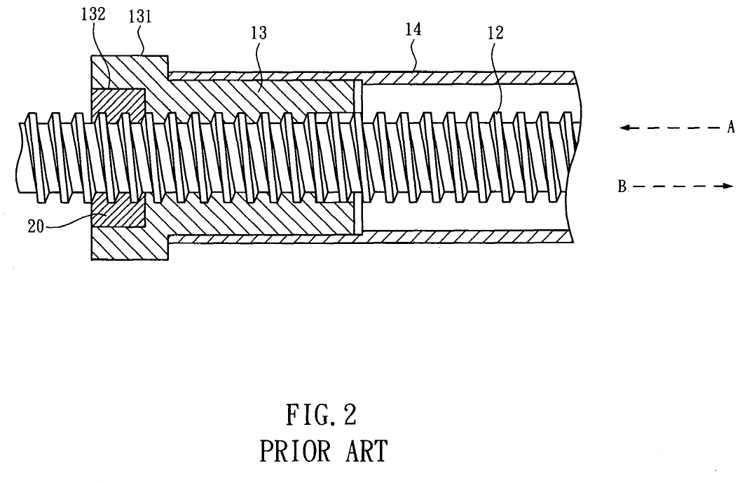

FIG. 3 is a partial sectional view showing the lead nut, safety nut and a locking nut of the present invention assembled to the conventional linear actuator;

FIG. 4 is a partial exploded view showing the lead nut, safety nut and locking nut of the present invention assembled to a screw of a conventional linear actuator; and

FIG. 5 is an exploded view of the disclosed components of the present invention shown in FIG. 4.

### DETAILED DESCRIPTION OF THE PREFERRED EMBODIMENT

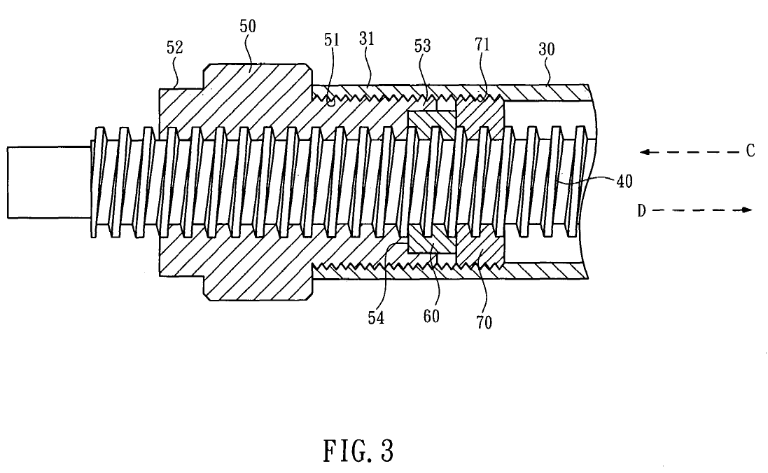

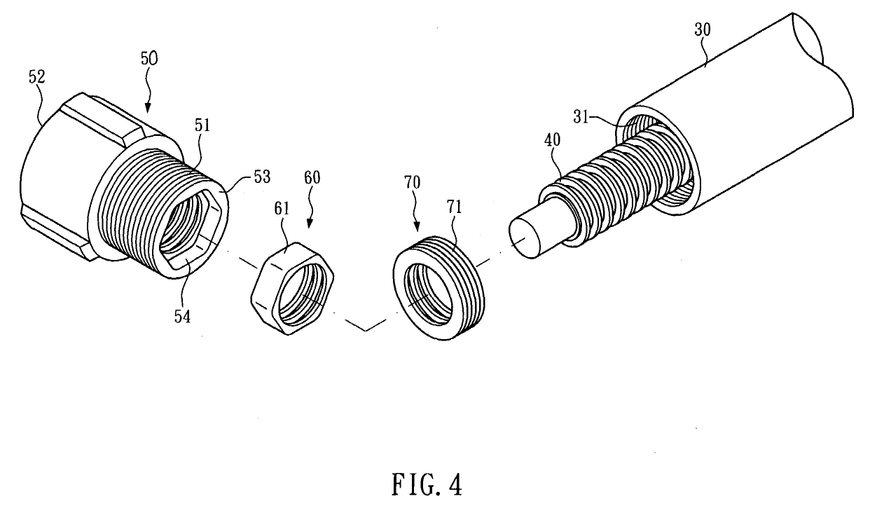

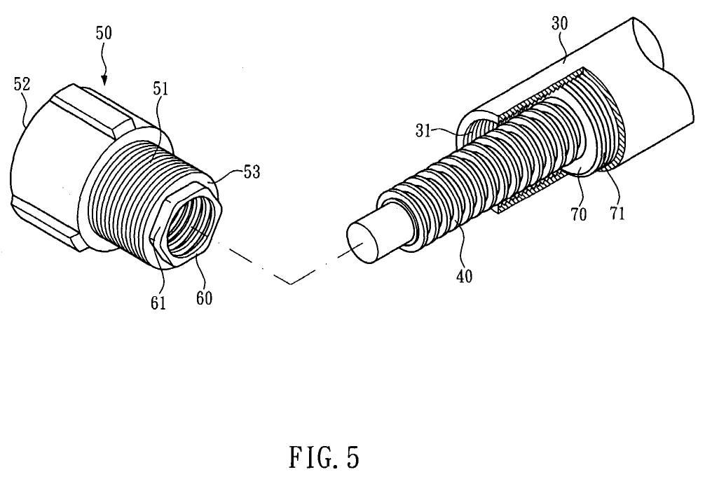

FIGS. 3, 4 and 5 are provided for illustrating the disclosed nut assembly configured with a conventional linear actuator. Through the drawings, an inner tube 30, a lead screw 40, a lead nut 50, a safety nut 60 and a locking nut 70 can be seen clearly. The lead nut 50 is assembled to the lead screw 40 and has an externally threaded segment 51 for being coupled with an interiorly threaded segment 31 provided at the end of the inner tune 30.

Two ends along the axis of the lead nut 50 are defined as a head end 52 and a tail end 53 wherein the tail end 53 comprises an assembling room 54 for accommodating said safety nut 60. According to the present embodiment, the contour of the assembling room 54 and the outer contour 61 of the safety nut 60 are both in a polygonal-sectioned shape so as to be engaged mutually. Foresaid polygonal-sectioned shape can include, but not limit to, a hexagonal-sectioned shape as shown in the exemplificative drawings.

The locking nut 70 has its externally threaded segment 71 engaged with the interiorly threaded segment 31 of the inner tune 30, and the lead screw 40 passes through the locking nut 70 without contacting the same.

When the lead nut 50 is assembled to the safety nut 60 at the end of the inner tube 30, the opposite ends of the safety nut 60 can be respectively retained by the lead nut 50 and the locking nut 70.

As described previously, normally, rotation of the lead screw 40 can synchronously lead the lead nut 50 and the safety nut 60 to shift linearly along the axial of the lead screw 40 and in turn affect the inner tube 30 to move forward or backward for achieving a desired movement of linear extension or contraction. Nevertheless, when thread damage of the lead nut 50 occurs, the safety nut 60 is designed to act as a reserve of the lead nut 50 to carry on the task of bearing loads.

It is to be noted that the safety nut 60 of the present invention is capable of bearing both a tensile load and a thrust load. According to the present invention, the safety nut 60 is settled at the tail end of the lead nut 50, and the locking nut 70 is provided in the inner tube 30 so that the two ends of the safety nut 60 can be respectively retained by the lead nut 50 and the locking nut 70 whereby the safety nut 60 can function despite the linear actuator is bearing a tensile load or a thrust load.

Please refer to FIG. 3, wherein an Arrow C designates a thrust load burdened to the linear actuator. When the screw threads of the lead nut 50 for engaging the lead screw 40 are damaged, the lead nut 50 at this point fails to engage the lead screw 40 and in turn becomes unable to bear the thrust load C, the thrust load C can be directed to the safety nut 60 by the locking nut 70 so that the safety nut 60 can function as a substitute to bear the thrust load C at once.

Also referring to FIG. 3, another Arrow D designates a tensile load burdened to the linear actuator. When the screw threads of the lead nut 50 for engaging the lead screw 40 are damaged, the lead nut 50 at this point fails to engage the lead screw 40 and in turn becomes unable to bear the tensile load D, the lead nut 50 can be retained by the safety nut 60 against being dragged out directly by the tensile load D and since the safety nut 60 is retained by the locking nut 70 and lead nut 50, it can act instead of the lead nut 50 for bearing the tensile load D.

To sum up, in virtue of the unique configuration, the nut assembly of the present invention can act as a safe guard regardless of it is a tensile load or a thrust load burdened to the linear actuator. Hence, the disclosed subject matter is applicable to linear actuators bearing tensile loads or thrust loads.

Furthermore, the safety nut 60 and lead nut 50 of the present invention are designed in polygonal-sectioned shapes that are mutually mated so as to be engaged mutually. Thus, the safety nut 60 can be firmly retained by the lead nut 50 against revolving with the lead screw 40, and thereby the safety nut 60 can work as a substitute for the lead nut 50 handicapped by damaged threads without fail.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A nut assembly for a linear actuator which is applied to a lead screw and an inner tube of the linear actuator and comprises:
a lead nut, assembled to the lead screw and externally engaged with the end of the inner tube;
a locking nut, assembled at the end of the inner tube; and
a safety nut, assembled to the lead screw and be retained by the lead nut and locking nut at its opposite ends.

2. The nut assembly of claim 1, wherein the lead nut comprises an assembling room at the end adjacent to the safety nut for accommodating said safety nut.

3. The nut assembly of claim 2, wherein the assembling room is formed in a polygonal-sectioned shape and the safety nut has a corresponding polygonal-sectioned shape.

4. The nut assembly of claim 3, wherein the polygonal-sectioned shapes are hexagonal-sectioned shapes.

5. The nut assembly of claim 1, wherein the locking nut has an externally threaded segment thereof engaged with an interiorly threaded segment of the inner tube.
